(19) United States
(12) Patent Application Publication
(10) Pub. No.: US 2010/0320730 A1
(43) Pub. Date: Dec. 23, 2010

(54) Resiliently deformable padding installed on a hitch so as to protect bumpers

(76) Inventor: ERIC FERLAND, Quebec (CA)

Correspondence Address: Eric Farland, # 106, 3591 Gouin E., Montreal, QC, H1H 5V7, CA

(21) Appl. No.: 12/489,361

(22) Filed: Jun. 22, 2009

(51) Int. Cl. B60D 1/60

(52) U.S. Cl. 280/507

(57) ABSTRACT

A resiliently deformable protective padding system, has a padding element laterally connected to a trailer coupler in a movable configuration, the padding element comprising a groove having a predetermined size, the groove configured to engage an edge extending integrally from the trailer coupler.

### FIELD OF THE INVENTION

The present invention relates generally to hitches but more particularly to devices that insure protection to bumpers that may be damaged by a hitch.

### BACKGROUND OF THE INVENTION

A trailer hitch assembly presents an obstacle and can injure a person passing nearby. Moreover, when unhitching or hitching from and to a vehicle, it is possible that the user may temporarily lose control and that the hard metal of the trailer coupler hits the bumper of the car with such impact as to cause damage.

Several proposals exist and some are even commercially available such as cushioned protectors having a flexible polymeric U-shaped element which laterally bounds the trailer hitch assembly and thereby creates a cushion zone.

Another example consists in a one-piece U-shaped flexible body member adapted to being positioned onto the upper surface of the trailer hitch while the hitch ball is removed. An aperture is formed in the flexible body member to allow the hitch ball to then be reattached to the tow bar tongue. A series of vertical cushioning ribs extend laterally from the side of the flexible body member to provide the cushioned protection.

Yet another example, U.S. Pat. No. 5,575,494 covers the trailer coupler instead of the trailer hitch. The bumper protector consists in a generally U-shaped member having a first longitudinal surface defining a contiguous inside perimeter of the U-shaped member. The first longitudinal surface has a channel formed therein extending the length of the inside perimeter of the U-shaped member.

The U-shaped member includes a first and a second leg extending laterally from a closed end of the U-shaped member. The first and second legs angle toward each other as they extend away from the closed end of the member so that the legs flex and releasably secure the U-shaped member when placed over the lateral marginal flange of the trailer coupler. In other words, only a frictional engagement secures the protecting device over the trailer coupler, which means that it do could easily be lost when the trailer travels on rough and bumpy roads. Vibration, wind and other such factors could easily loosen the protector. The polymeric material and the general shape of the device do not lend themselves to the use of mechanical fasteners for attachment to the trailer coupler.

### SUMMARY OF THE INVENTION

It is a main advantage of this invention to provide for an unobtrusive but efficient protector which is permanently installed on a trailer coupler.

Another advantage over bumper protectors of the prior art is that it is compact, which reduces costs for shipping, warehousing as well as retail shelf space—all important factors to reduce retail costs.

Yet another advantage of this invention is that it has the flexibility of shape which allows it to adapt to variations in shapes and sizes of the trailer coupler.

Yet another advantage of this invention is to offer two options for mechanically fastening to a trailer coupler.

Still another advantage of this invention is that it can be moved out of place while still being mechanically attached to the trailer coupler so as to allow for the installation of various anti theft devices.

In order to do so, the invention generally comprises a padding element laterally connected to a trailer coupler in a movable configuration, the padding element comprising a groove having a predetermined size, the groove configured to engage an edge extending integrally from the trailer coupler.

The padding element comprising at least two ends whereby each end comprising at least a grommet; a perforation; and an eyelet. Each of the grommet, the perforation, and the eyelet, configured to cause passage of a mechanical fastening device for securely attaching the padding element onto the trailer coupler.

The mechanical fastening device comprising at least one of the following: a nut; and a bolt.

The padding element is made up of a resiliently deformable elastomeric material adaptable to variation in shape of the trailer coupler.

In a variation of the embodiment, the protective padding assembly, has a padding element laterally connected to a trailer coupler in a protective configuration, the padding element comprising a groove having a predetermined size, the groove configured to engage an edge extending from integrally the trailer coupler, the padding element comprising a fastening surface further comprising at least two screw holes for passing metal screws across the fastening surface.

The method for protecting a bumper involves mounting the padding element in a movable manner onto a trailer coupler surface in a laterally protruding configuration. Configuring a groove of the padding element for engaging an edge extending integrally from the trailer coupler. And moving the padding element for liberating a ball unit to thereby enable installation of an anti theft unit, while an area covered by the padding element exceeds an area covered by the ball unit according to the laterally protruding configuration of the padding.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of the invention in context.

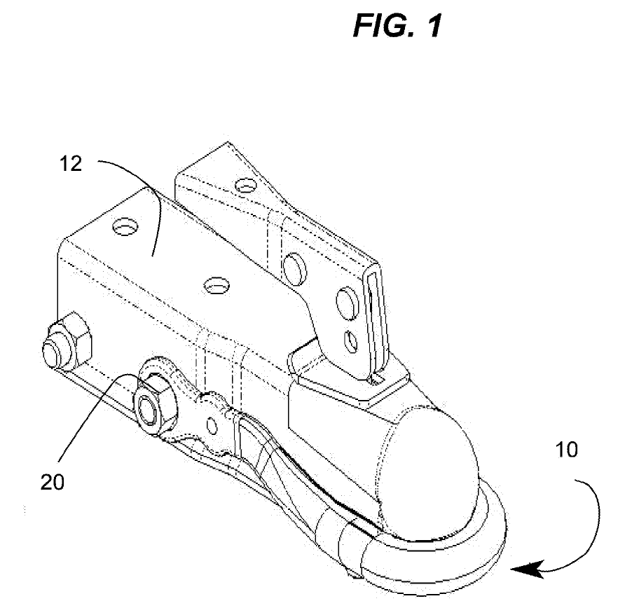

FIG. 2 Cutaway side view of the invention in context.

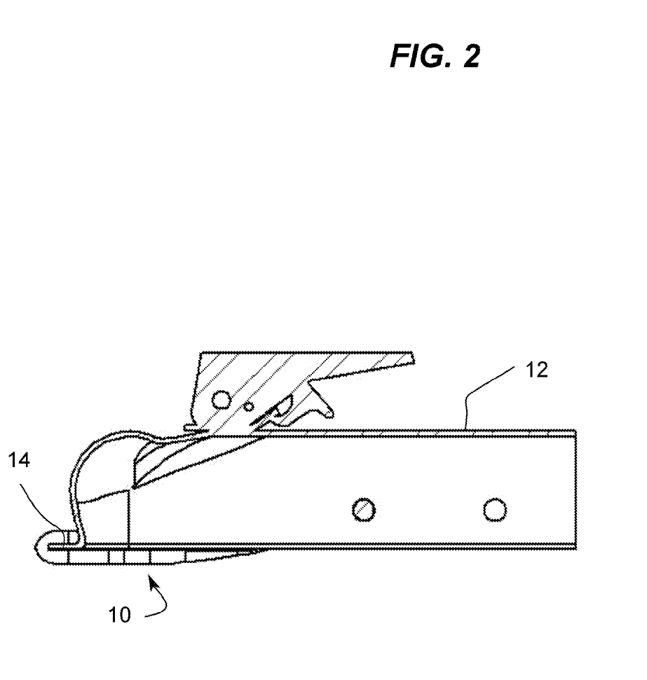

FIG. 3 Perspective view of an alternate embodiment of the invention, in context.

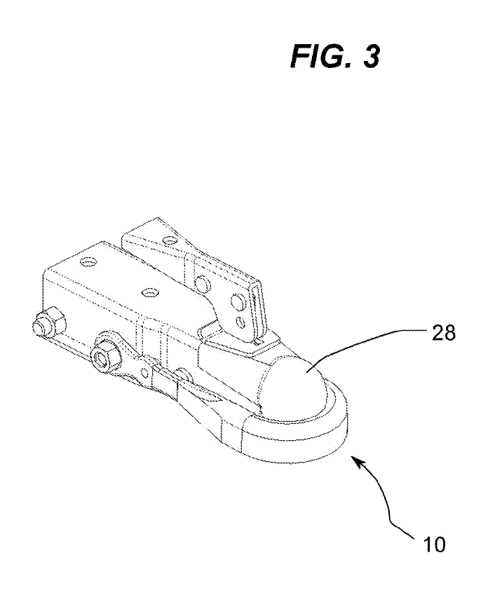

FIGS. 4a-c Side, front, and end, respectively, of the invention.

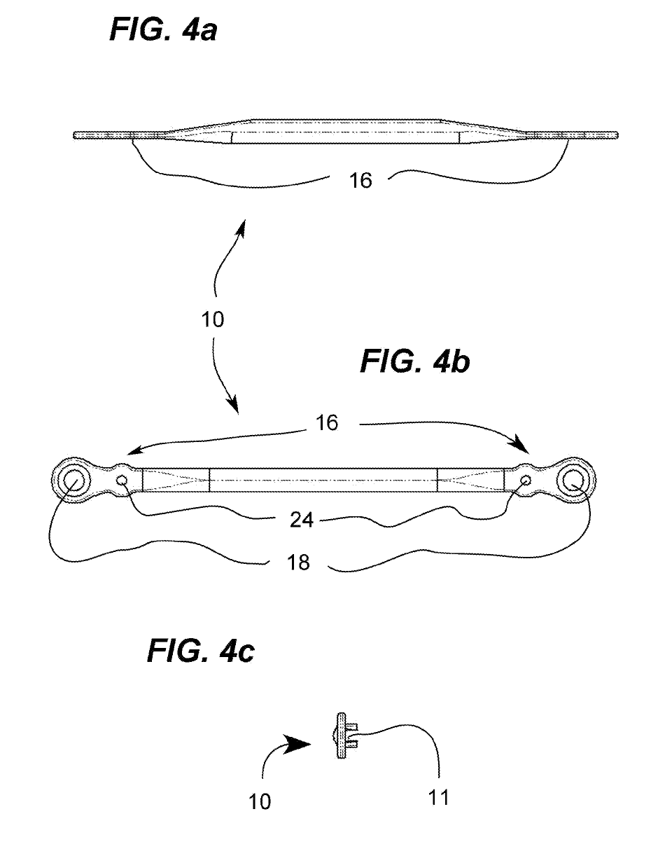

FIGS. 5a-c Side, front, and end, respectively, of the alternate embodiment of FIG. 3.

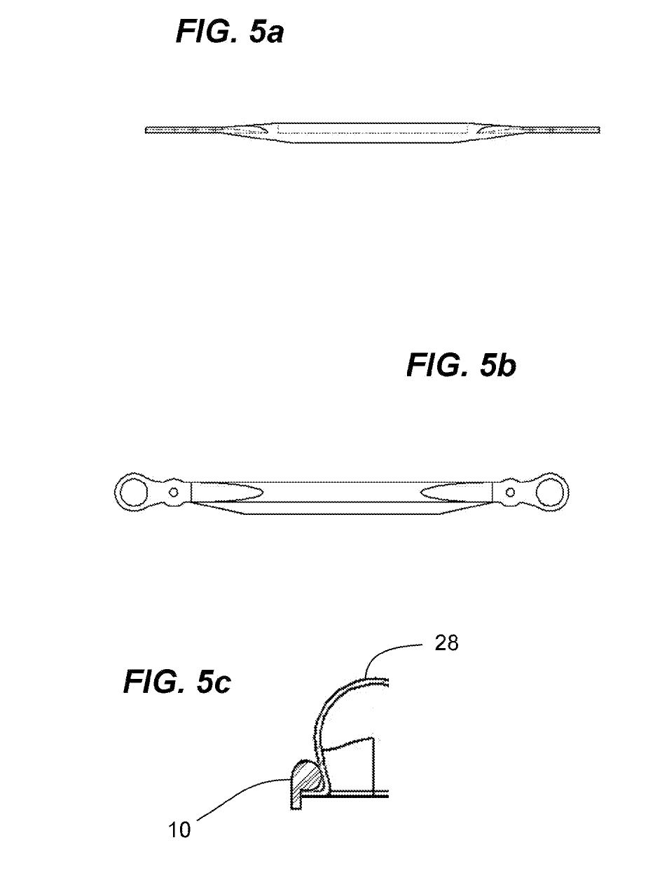

FIG. 6 Perspective view of the invention showing it disengaged,and with an anti-theft device on the dome.

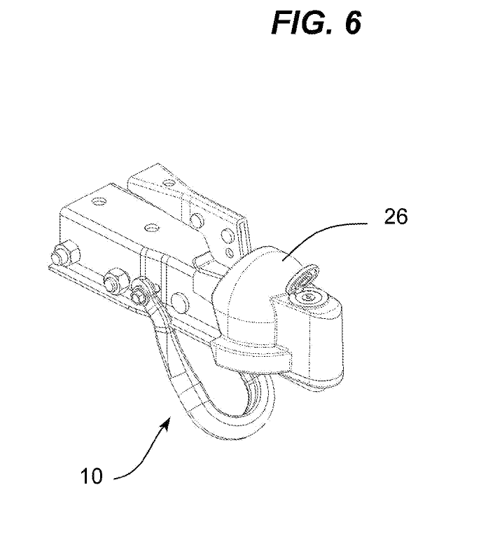

### DETAILED DESCRIPTION

A padding element (10) for a trailer coupler (12) is comprised of a groove (11) configured and sized to engage an edge (14) which extends integrally from the trailer coupler (12).

The padding element (10) has two ends (16), each end (16) having a grommet (18) which allows for the passage of a mechanical fastener (20) such as a bolt which securedly attaches the padding element (10) onto the trailer coupler (12).

Trailer couplers (12) are usually bolted to a tow bar (not shown) and therefore, making use of existing components makes sense. Although trailer couplers (12) are pretty much standard, there are still variations in shapes and sizes. The flexible nature of the padding element (10) which is made from an elastomer material and has a straight shape which is pliable and can be deformed to fit a variety of shapes can handle any variation in trailer coupler (12) shape. Also, depending upon the shape of the trailer coupler (12) and the location of the existing mechanical fasteners (20) on the trailer coupler (12), at times, it may be impossible to use the grommets (18). In such cases, metal screws (not shown) can be used in order to mechanically fasten the padding element (10) onto the trailer coupler (12). Screw holes (24), located the grommets (16) on the ends (16) are used for passing the metal screws (not shown) therethrough. The metal screws (not shown) can be of the self-tapping type. Of course, one could use nuts and bolts there as well.

Independently of whether the grommets (18) or the screw holes (24) are used in fastening the padding element (10) to the trailer coupler (12), the padding element (10) can be moved so as to liberate a ball (28), part of the the trailer coupler (12) and allow an anti theft device (26) to be installed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A resiliently deformable protective padding system, comprising:
a padding element laterally connected to a trailer coupler in a movable configuration, the padding element comprising a groove having a predetermined size, the groove configured to engage an edge extending integrally from the trailer coupler.

2. The resiliently deformable protective padding system of claim 1, wherein the padding element comprising at least two ends whereby each end comprising at least one of the following:
a grommet; a perforation; and an eyelet.

3. The resiliently deformable protective padding system of claim 2, wherein each of the: grommet; the perforation: and the eyelet, configured to cause passage of a mechanical fastening device for securely attaching the padding element onto the trailer coupler.

4. The resiliently deformable protective padding system of claim 3, wherein the mechanical fastening device comprising at least one of the following: a nut; and a bolt.

5. The resiliently deformable protective padding system of claim 1, wherein the padding element is made up of a resiliently deformable elastomeric material adaptable to variation in shape of the trailer coupler.

6. A protective padding assembly, comprising:
a padding element laterally connected to a trailer coupler in a protective configuration, the padding element comprising a groove having a predetermined size, the groove configured to engage an edge extending from integrally the trailer coupler, the padding element comprising a fastening surface further comprising at least two screw holes for passing metal screws across the fastening surface.

7. The protective padding assembly of claim 6, wherein metal screws comprising a self tapping configuration.

8. The protective padding assembly of claim 6, wherein the metal screws comprising at least one of: a plurality of nuts; and a plurality of bolts.

9. A method for protecting bumpers from a trailer hitch assembly in a trailer coupler system, comprising:
mounting a padding element in a movable manner onto a trailer coupler surface in a laterally protruding configuration;
configuring a groove of the padding element for engaging an edge extending integrally from the trailer coupler; and
moving the padding element for liberating a ball unit to thereby enable installation of an anti theft unit, while an area covered by the padding element exceeds an area covered by the ball unit according to the laterally protruding configuration of the padding element.

10. The method of claim 9, wherein a boundary of the ball unit follows a boundary of the padding element while the ball unit is an inner unit and the padding element is an outer unit of the trailer coupler system.

11. The method of claim 10, wherein a radius of the padding element exceeds a radius of the ball unit.

12. The method of claim 9, comprising a sub step of enabling a passage of a mechanical fastener through a fastening surface of the trailer coupler system for securely attaching the padding element onto the trailer coupler.

13. The method of claim 9, wherein the padding element is adaptable to a variation in a shape of the trailer coupler surface.

14. The method of claim 13, wherein the padding element us adaptable to a variation in configuration of fastening elements including: grommets; screws; nuts; and bolts.

15. The method of claim 14, wherein the padding element is made up of a resiliently deformable elastomeric material.

16. The method of claim 9, wherein the step of configuring the groove of the padding element for engaging the edge extending integrally from the trailer coupler comprising a sub step of sizing the edge of the trailer coupler system.
